(19) United States
(12) Patent Application Publication
(10) Pub. No.: US 2008/0247597 A1
(43) Pub. Date: Oct. 9, 2008

(54) DEVICE FOR DETECTING DIGITAL WATERMARK

(76) Inventor: Taichi Isogai, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/061,327

(22) Filed: Apr. 2, 2008

(30) Foreign Application Priority Data
Apr. 3, 2007 (JP) P2007-097235

(51) Int. Cl. G06K 9/00

(52) U.S. Cl. 382/100

(57) ABSTRACT

A device includes: a reception unit that receives video image; an extraction unit that extracts the watermark patterns from the video image; a storage unit that stores an accumulated information pieces and a number of accumulation times; a calculation unit that calculates degrees of correlation between the accumulated information pieces and the watermark patterns; an accumulation unit that accumulates the watermark patterns in one of the accumulated information pieces having the degree of correlation that is larger than a threshold value and is the largest among the calculated degrees of correlation; a selection unit that selects a top N-pieces of the accumulated information pieces stored in the storage unit having largest number of the accumulation times, where N is a positive integer; and a watermark value calculation unit that obtains a digital watermark value from the accumulated information pieces selected by the selection unit.

### RELATED APPLICATION(S)

The present disclosure relates to the subject matter contained in Japanese Patent Application No. 2007-097235 filed on Apr. 3, 2007, which is incorporated herein by reference in its entirety.

### FIELD

The present invention relates to a digital watermark detecting device, a video player, a video copying apparatus, and a program product for detecting digital watermark.

### BACKGROUND

A method using a digital watermark is known as a countermeasure for pirating of digital contents. As digital watermark, information such as copyright information, user identification information, and copy control information are embedded in original information (original contents), such as each frame of an original video, by modifying the original contents to such an extent that is unrecognizable by a user. In modifying the original information, a minute and patterned modification is added to an image of each frame of the original video. A digital watermark value is obtained by the watermark pattern. The digital watermark value indicates additional information such as copyright information.

However, when the video image including watermark patterns is compressed in accordance with MPEG (Moving Picture Experts Group) standards and is thus deteriorated, the watermark patterns becomes difficult to detect.

As a technique to detect watermark patterns with high detection precision from deteriorated video image, there is proposed a method for extracting the watermark patterns selectively from less deteriorated frames and accumulating the watermark patterns. An example of such method is disclosed in JP-A-2004-166018.

In a digital watermark detecting device that detects digital watermark, it is preferable that the device should be able to detect watermark patterns embedded in various digital watermark forms. However, in the method described in JP-A-2004-166018, a plurality of watermark patterns cannot be accumulated. Accordingly, the method is unable to be used for obtaining digital watermark value for a type of digital watermark in which the digital watermark value is obtained from a plurality of watermark patterns, and is not sufficient for enhancing the detection precision of the watermark patterns.

The same problem arises when using the method described in JP-A-2004-166018 to a type of digital watermark in which a single digital watermark value is obtained from a single watermark pattern, but the same watermark pattern is not embedded throughout the video image.

### SUMMARY

According to a first aspect of the invention, there is provided a device for detecting digital watermark from video image in which a plurality of types of watermark patterns are embedded, the device including: a reception unit that receives the video image; an extraction unit that extracts the watermark patterns from the video image; a storage unit that stores an accumulated information pieces and a number of accumulation times, the accumulated information pieces being obtained by accumulating the watermark patterns for each type of the watermark patterns; a calculation unit that calculates degrees of correlation between the accumulated information pieces stored in the storage unit and the watermark patterns extracted by the extraction unit; an accumulation unit that accumulates the watermark patterns extracted by the extraction unit in one of the accumulated information pieces having the degree of correlation that is larger than a threshold value and is the largest among the calculated degrees of correlation; a selection unit that selects a top N-pieces of the accumulated information pieces stored in the storage unit having largest number of the accumulation times, where N is a positive integer; and a watermark value calculation unit that obtains a digital watermark value from the accumulated information pieces selected by the selection unit.

According to a second aspect of the invention, there is provided a video player including: the device according to the first aspect; a video storage unit that stores the video image; a reproduction unit that reproduces the video image stored in the video storage unit; a control unit that controls the reproduction unit to enable or disable the reproduction of the video image based on the digital watermark value obtained by the watermark value calculation unit.

According to a third aspect of the invention, there is provided a video copying apparatus including: the device according to the first aspect; a first video storage unit that stores the video image embedded with the watermark patterns; a second video storage unit that stores a copy of the video image stored in the first video storage unit; a copying unit that copies the video image stored in the first video storage unit to the second video storage unit; and a control unit that controls the copying unit to enable or disable the copy of the video image based on the digital watermark value obtained by the watermark value calculation unit.

According to a fourth aspect of the invention, there is provided a computer-readable storage medium that contains a software program for causing a computer to perform a process for detecting digital watermark from video image in which a plurality of types of watermark patterns are embedded, the process including: receiving the video image; extracting the watermark patterns from the video image; storing an accumulated information pieces and a number of accumulation times, the accumulated information pieces being obtained by accumulating the watermark patterns for each type of the watermark patterns; calculating degrees of correlation between the stored accumulated information pieces and the watermark patterns; accumulating the watermark patterns in one of the accumulated information pieces having the degree of correlation that is larger than a threshold value and is the largest among the calculated degrees of correlation; selecting a top N-pieces of the stored accumulated information pieces having largest number of the accumulation times, where N is a positive integer; and obtaining a digital watermark value from the selected accumulated information pieces.

### BRIEF DESCRIPTION OF THE DRAWINGS

In the accompanying drawings:

FIG. 1 a block diagram illustrating a configuration of a digital watermark detecting device according to a first embodiment of the present invention;

FIG. 2 is a diagram illustrating a sequence of watermark patterns embedded in frames of video image;

FIG. 3 is a flowchart illustrating an operation of the digital watermark detecting device according to the first embodiment;

FIG. 4 is a diagram illustrating a sequence of watermark patterns embedded in frames of video image;

FIG. 5 is a block diagram illustrating a configuration of a video player according to a second embodiment of the present invention;

FIG. 6 is a flowchart illustrating an operation of the video player according to the second embodiment;

FIG. 7 is a block diagram illustrating a configuration of a video copying apparatus according to a third embodiment of the present invention;

FIG. 8 is a block diagram illustrating an operation of the video copying apparatus according to the third embodiment;

FIG. 9 is a block diagram illustrating a configuration of a computer executing a digital watermark detecting program according to a fourth embodiment of the present invention;

FIG. 10 is a block diagram illustrating an operation of the digital watermark detecting program according to the fourth embodiment; and

FIG. 11 is a flowchart illustrating an operation of routine R of the digital watermark detecting program according to the fourth embodiment.

### DETAILED DESCRIPTION OF THE EMBODIMENTS

Hereinafter, embodiments of the invention will be described.

### First Embodiment

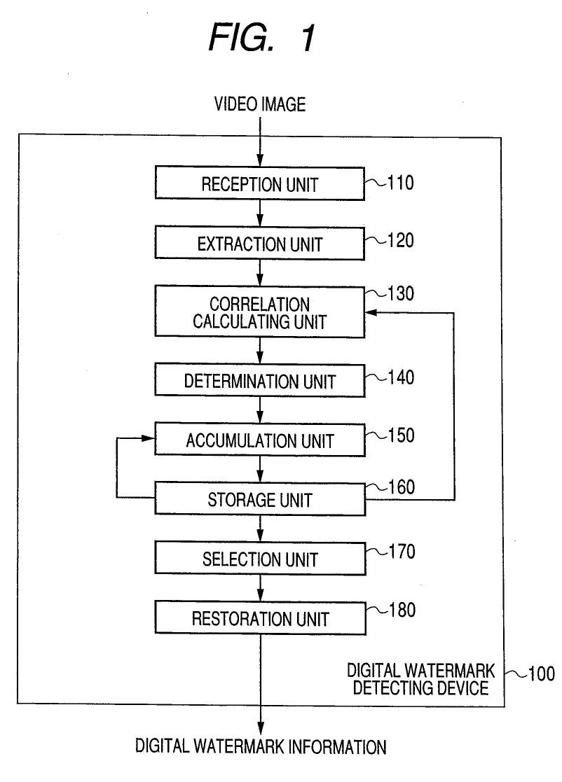

FIG. 1 is a block diagram illustrating a digital watermark detecting device 100 according to a first embodiment of the present invention.

The digital watermark detecting device 100 includes: a reception unit 110 that receives video image in which watermark patterns for obtaining a digital watermark value are embedded; an extraction unit 120 that extracts the watermark patterns from the video image received by the reception unit 110; a storage unit 160 that stores an accumulated information piece and the number of accumulation times of each type of the watermark patterns extracted by the extraction unit 120; a correlation calculating unit 130 that calculates a degree of correlation between the watermark patterns extracted by the extraction unit 120 and the accumulated information pieces of the watermark patterns accumulated in the storage unit 160; a determination unit 140 that determines the same type of watermark patterns as the extracted watermark patterns on the basis of the degrees of correlation calculated by the correlation calculating unit 130; an accumulation unit 150 that accumulates the extracted watermark patterns in the accumulated information piece of the watermark pattern determined as the same type by the determination unit 140; a selection unit 170 that selects accumulated information pieces used to obtain the digital watermark value on the basis of the accumulated information pieces stored in the storage unit 160; and a watermark value calculation unit 180 that obtains and outputs the digital watermark value from the accumulated information pieces selected by the selection unit 170.

The video image includes slightly different video image pieces (frames) which are sequentially displayed at the time of reproduction. By slightly modifying information, such as brightness and RGB, of a specific area (pattern) of the video image piece called the frame, a single watermark pattern is embedded in the single frame. The watermark pattern is a watermark image embedded in the frame of the video image.

In the embodiment, single watermark pattern is embedded in single frame using a method of embedding a watermark in a frequency domain after an orthogonal transform such as a DCT (Discrete Cosine Transform) as the method of embedding the watermark patterns.

Here, the watermark patterns embedded as digital watermark values in the video image are generated based on a homotopy class, which is a topological invariant quantity, and a single digital watermark value is constructed of three types of watermark patterns (X, Y, and Z).

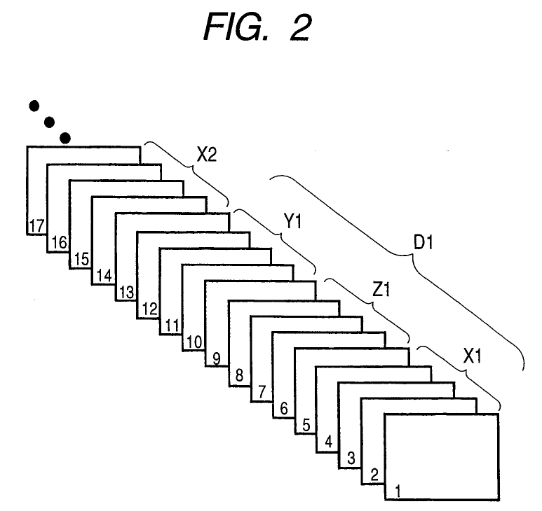

FIG. 2 shows a sequence of embedding the watermark patterns in the frames of the video image. In the example shown in FIG. 2, a “watermark pattern of X”, a “watermark pattern of Z”, and a “watermark pattern of Y” are repeatedly embedded in this order. In other words, the watermark patterns “X1”, “Z1”, “Y1”, “X2”, “Z2”, “Y2”, . . . are embedded by repeating the order of XZY. One digital watermark value “D1” is obtained by three types of watermark patterns “X1”, “Z1”, and “Y1”.

In consideration that any one of the frames is omitted due to compression or loss of the video image, for example, four watermark patterns of each of X, Y, and Z are consecutively embedded, such as “X1, X1, X1, and X1”.

The storage unit 160 stores accumulated information pieces in which the extracted watermark patterns are accumulated every type and the number of accumulation times. The storage unit 160 has an area for storing 20 sets of accumulated information pieces and numbers of accumulation times.

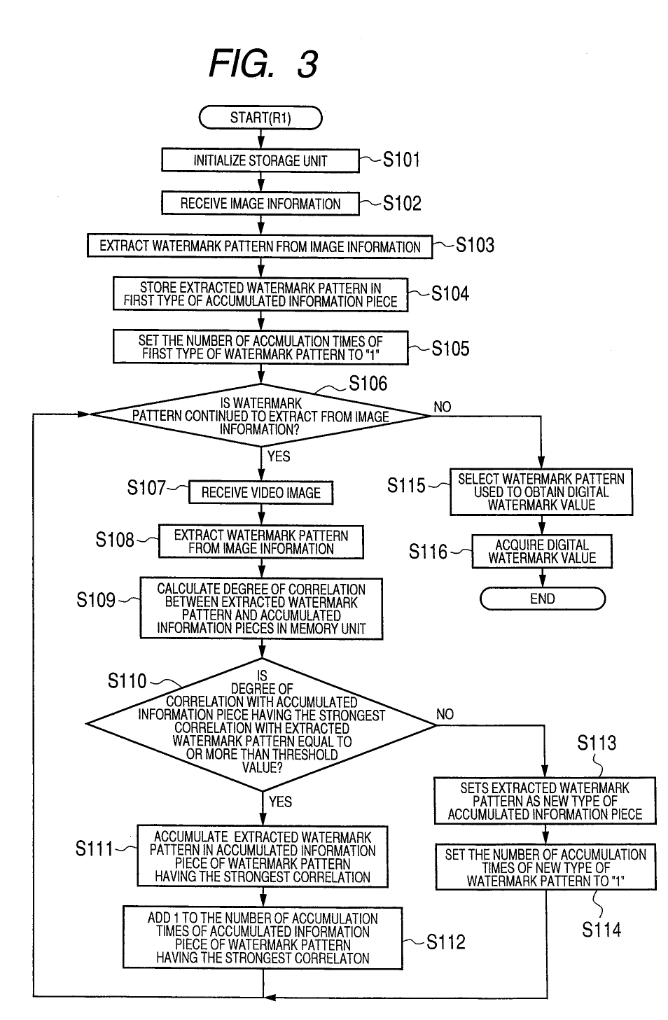

FIG. 3 shows a flowchart illustrating an operation of the digital watermark detecting device 100 according to the first embodiment of the invention. First, the storage unit 160 is initialized (step S101). When initialized, the accumulated information pieces and the numbers of accumulation times stored in the storage unit 160 are set to “0”.

Next, the reception unit 110 receives video image (step S102). The watermark patterns are embedded in the frames of the received video image, respectively.

Next, the extraction unit 120 extracts the watermark patterns from the video image received by the reception unit 110 (step S103).

Next, the correlation calculating unit 130 receives the watermark patterns extracted by the extraction unit 120. In this step, since the accumulated information pieces of the watermark patterns are not stored in the storage unit 160, the degree of correlation is not calculated. The correlation calculating unit 130 transmits the watermark patterns extracted by the extraction unit 120 to the accumulation unit 150.

When the receiving the watermark patterns extracted by the extraction unit 120 from the correlation calculating unit 130, the accumulation unit 150 stores the watermark patterns as a first type of watermark patterns in the storage unit 160. The accumulation unit 150 stores the watermark patterns extracted by the extraction unit 120 as the accumulated information in the storage unit 160 (step S104), sets the number of accumulation times to “1”, and stores the set number of accumulation times in the storage unit 160 (step S105).

Then, the reception unit 110 determines whether to continue to extract the watermark patterns from the video image (step S106). Methods used for the reception unit 110 to determine whether to continue to extract the watermark patterns from the video image are classified into the following three methods.

A first method is to make the determination on the basis whether a next frame exists in the video image. When a next frame in the video image received by the reception unit 110 exists, the reception unit determines that the watermark pattern is continued to extract from the video image. When a next frame does not exist in the video image received by the reception unit 110, the reception unit determines that the watermark pattern is not continued to extract from the video image.

A second method is to make the determination on the basis whether a scene is modified. When a scene is not modified in the video image received by the reception unit 110, the reception unit determines that the watermark pattern is continued to extract from the video image. When a scene is modified in the video image received by the reception unit 110, the reception unit determines that the watermark pattern is not continued to extract from the video image. The scene modification in the video image is detected from a brightness difference between the adjacent frames or a motion vector between the adjacent frames.

A third method is to make the determination on the basis whether a predetermined time passes. A timer is disposed in the reception unit 110 to measure the time after the digital watermark value is once acquired. When the value measured by the timer is less than a predetermined value, the reception unit determines that the watermark pattern is continued to extract from the video image. On the other hand, when the value measured by the timer is not less than a predetermined value, the reception unit determines to terminate extracting the watermark pattern from the video image.

When the reception unit 110 determines that extracting the watermark patterns from the video image is to be terminated, a digital watermark value is acquired on the basis of the accumulated information pieces stored in the storage unit 160 at that time (steps S115 and S116).

On the other hand, when the reception unit 110 determines to continue extracting the watermark pattern from the video image, the reception unit 110 receives next video image (frame) (step S107). Then, the extraction unit 120 extracts the watermark patterns from the received video image, similarly to step S103 (step S108).

Next, the correlation calculating unit 130 calculates the degrees of correlation between the watermark patterns extracted by the extraction unit 120 and the accumulated information pieces stored in the storage unit 160 for each type of the accumulated information pieces (step S109). Since 20 sets of the number of accumulation times and the accumulated information piece in maximum are stored in the storage unit 160, the correlation calculating unit 130 calculates 20 degrees of correlation between the watermark patterns extracted by the extraction unit 120 and the accumulated information pieces stored in the storage unit 160.

The degree of correlation is an indicator that indicates a correlation between two watermark patterns. For example, when two watermark patterns are completely equal to each other, the degree of correlation is set to the largest.

The determination unit 140 compares the largest degree of correlation among the degrees of correlation calculated by the correlation calculating unit 130 and a predetermined threshold value (step S110). The threshold value is the lower limit of the degree of correlation allowed to determine that the watermark pattern extracted by the extraction unit 120 is the same type as the accumulated information piece stored in the storage unit 160.

When the largest degree of correlation is larger than the threshold value, the determination unit 140 determines that the accumulated information piece having the largest degree of correlation is an accumulation destination (Yes in step S110). The accumulation unit 150 accumulates the watermark pattern extracted by the extraction unit 120 in the storage unit 160 in which the accumulation destination (the accumulated information piece of which the degree of correlation is the largest or more than the threshold value) determined by the determination unit 140 (step S111).

The accumulation unit 150 adds “1” to the number of accumulation times corresponding to the accumulated information piece of the accumulation destination determined by the determination unit 140 and accumulates the added value (step S112).

On the other hand, when the largest degree of correlation is less than the threshold value, it is determined that the type of the watermark pattern extracted by the extraction unit 120 is not matched with any type of watermark patterns of the accumulated information pieces stored in the storage unit 160 (No in step S110). That is, the determination unit 140 determines that the watermark pattern extracted by the extraction unit 120 is a new type of watermark pattern. Accordingly, the accumulation unit 150 stores the watermark pattern extracted by the extraction unit 120 as a new type of watermark pattern in the storage unit 160. That is, the accumulation unit 150 accumulates the extracted watermark pattern in the accumulated information piece of the set of which the number of accumulation times is “0” in the storage unit 160 (step S113), sets the number of accumulation times to “1”, and stores the set number of accumulation times in the storage unit 160 (step S114).

When a set of which the number of accumulation times is “0” does not exist in the storage unit 160, the accumulation unit 150 initializes the set of the accumulation information piece and the number of accumulation times of which the number of accumulation times is the smallest and which is stored in the storage unit 160 for the longest time. Here, the accumulated information piece of which the number of accumulation times is the smallest is considered that it is determined as a type of watermark pattern different from the original types of watermark patterns due to noises and the like.

When the reception unit 110 determines in step S106 that the watermark pattern is continued to extract and accumulate from the video image (Yes in step S106), the processes of steps S107 to S114 or the processes of steps S107 to S112 are repeatedly performed.

On the other hand, when the reception unit 110 determines to terminate the extraction and the accumulation of the watermark pattern from the video image (No in step S106), the selection unit 170 selects the watermark pattern used for the digital watermark value from the accumulated information pieces stored in the storage unit 160 (step S115). That is, since one digital watermark value is obtained by three types of watermark patterns in this digital watermark form, the selection unit 170 selects three accumulated information pieces as the watermark patterns used for the digital watermark value in the order decreasing from the largest number of accumulation times. For example, in a digital watermark form in which a single digital watermark value is obtained from a single watermark pattern, the selection unit 170 can select the accumulated information piece having the largest number of accumulation times as the watermark pattern used for the digital watermark value.

Next, the watermark value calculation unit 180 outputs a digital watermark value from the watermark patterns selected by the selection unit 170 (step S116). That is, the watermark value calculation unit 180 acquires and outputs one digital watermark value (Dn) on the basis of three types of accumulated information pieces (watermark pattern of Xn, watermark pattern of Yn, and watermark pattern of Zn) which are used for the digital watermark value and which are selected by the selection unit 170 (where n is a positive integer).

Accordingly, in the digital watermark detecting device 100 according to the first embodiment, it is possible to enhance the detection precision of a digital watermark value in the digital watermark form in which one digital watermark value is obtained by plural types of watermark patterns.

In the digital watermark form in which one digital watermark value is obtained by one type of watermark pattern, when the same type of watermark pattern is not embedded in the frames of the video image, for example, when different types of watermark patterns are alternately embedded, the digital watermark detecting device 100 according to the first embodiment is applicable.

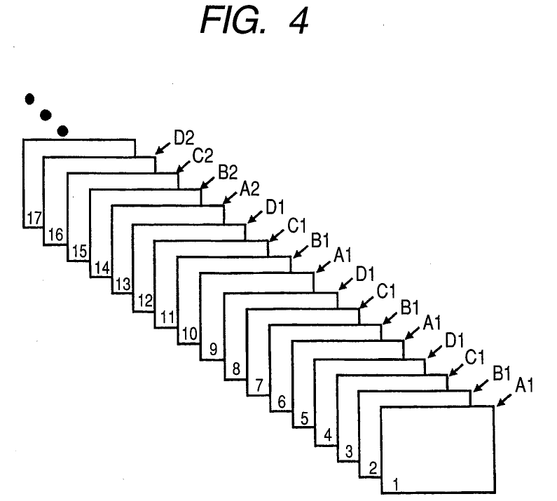

FIG. 4 shows another example of a sequence of watermark patterns embedded in the frames of the video image. In this example, four different types of watermark patterns are alternately embedded in the frames of the video image. In FIG. 4, a “watermark pattern of A1”, a “watermark pattern of B1”, a “watermark pattern of C1”, and a “watermark pattern of D1” are alternately embedded in this order. In FIG. 4, in consideration that a frame is omitted due to compression or loss of the video image, for example, a set of “A1, B1, C1, and D1” is consecutively and repeatedly embedded three times.

An operation of the digital watermark detecting device 100 when the watermark patterns shown in FIG. 4 are embedded in the video image will be described with reference to FIG. 3. The operation of the digital watermark detecting device 100 in step S101 to S114 is similar to the first embodiment and thus description thereof is omitted.

In step S115, since four types of watermark patterns are embedded in four frames of the video image, the selection unit 170 selects four accumulated information pieces in the order decreasing from the largest number of accumulation times as the watermark patterns.

In step S116, the watermark value calculation unit 180 sets the digital watermark value from the watermark patterns selected by the selection unit 170. Here, the watermark value calculation unit 180 sets four digital watermark values (DAn, DBn, DCn, and DDn) (where n is a positive integer) on the basis of the four types of accumulated information piece (the watermark pattern of An, the watermark pattern of Bn, the watermark pattern of Cn, and the watermark pattern of Dn).

Accordingly, in the digital watermark detecting device 100 according to the first embodiment, when the same type of watermark patterns are not continuously embedded in the frames of the video image in the digital watermark form in which one digital watermark value is obtained by one type of watermark pattern, it is possible to enhance the detection precision of a digital watermark value.

In steps S103 and S108 shown in FIG. 3, a step of determining whether a watermark pattern is embedded in the video image may be provided before the extraction unit 120 extracts the watermark pattern from the video image. When it is determined that the watermark pattern is not embedded in the video image, the processes of steps S102 and S170 shown in FIG. 3 are performed. On the other hand, when it is determined that the watermark pattern is embedded in the video image, the processes subsequent to steps S103 and S108 are performed.

By performing the determination, for determining whether the watermark pattern is embedded in the video image, before performing steps S103 and S108, it is possible to enhance the detection precision of a digital watermark value.

The digital watermark detecting device 100 can be embodied, for example, by using a general-purpose computer as hardware. That is, the reception unit 110, the extraction unit 120, the correlation calculating unit 130, the determination unit 140, the accumulation unit 150, the selection unit 170, and the watermark value calculation unit 180 can be embodied by allowing a processor mounted on the computer to execute a program. Here, the digital watermark detecting device 100 may be embodied by installing the program in the computer, or storing the program in a storage medium such as a CD-ROM or distributing the program through a network to install the program in the computer. The storage unit 160 may be embodied using a memory built in or out the computer, a hard disk, and a storage medium such as CD-R, CD-RW, DVD-RAM, and DVD-R.

### Second Embodiment

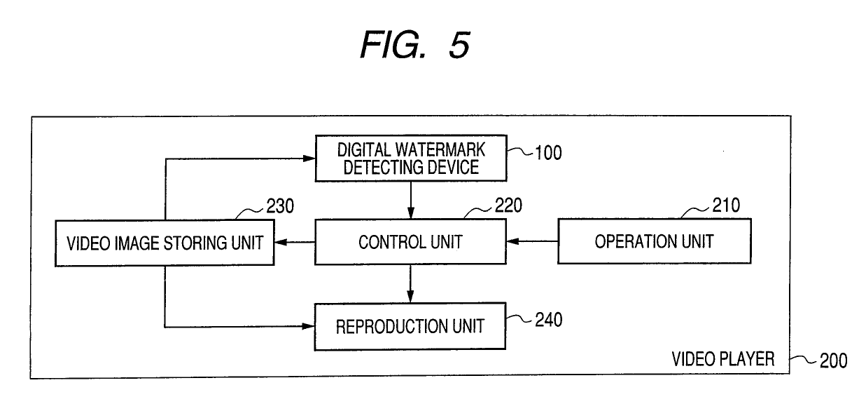

FIG. 5 shows a block diagram illustrating a configuration in which the above-mentioned digital watermark detecting device 100 is mounted on a video player 200 according to a second embodiment of the present invention. Since the configuration of the digital watermark detecting device 100 are similar to that of the first embodiment, the elements thereof are denoted by like reference numerals and description thereof is omitted.

The video player 200 according to the second embodiment includes: an operation unit 210 to which a user performs an input operation of the video player 200; a video image storing unit 230 that stores video image in which watermark patterns for obtaining a digital watermark value are embedded; a reproduction unit 240 that reproduces the video image stored in the video image storing unit 230; a digital watermark detecting device 100 that detects the digital watermark value of the video image from the video image storing unit 230; and a control unit 220 that controls the reproduction unit 240 to enable or disable the reproduction of the video image in accordance with the digital watermark value from the digital watermark detecting device 100.

The video image storing unit 230 can be embodied using a memory built in or attached to the video player 200, a hard disk, and a storage medium such as CD-R, CD-RW, DVD-RAM, and DVD-R.

The digital watermark value of the watermark patterns embedded in the video image indicates, for example, user identification information.

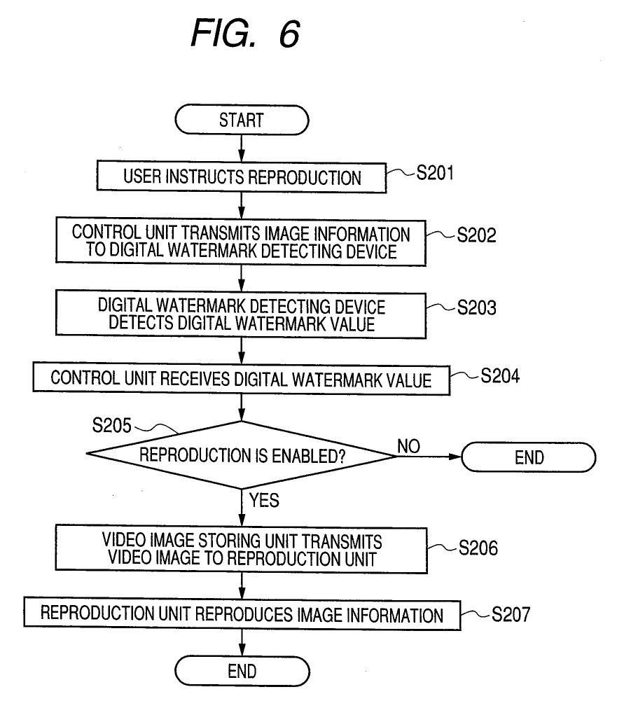

FIG. 6 shows a flowchart illustrating an operation of the video player 200 according to the second embodiment.

First, the video player 200 is instructed to reproduce the video image by means of the operation of the operation unit 210 (step S201). That is, a command instructing a reproduction process is transmitted to the control unit 220 from the operation unit 210 in accordance with an operation input by the user.

Next, when receiving the command instructing the reproduction process from the operation unit 210, the control unit 220 transmits a command for reading the stored video image and transmitting the read video image to the digital watermark detecting device 100 to the video image storing unit 230. The video image storing unit 230 having received the command reads the stored video image and transmits the read video image to the digital watermark detecting device 100 in accordance with the command (step S202).

The digital watermark detecting device 100 detects a digital watermark value from the watermark patterns embedded in the received video image (step S203). The method of allowing the digital watermark detecting device 100 to detect the digital watermark value from the video image is as described in the first embodiment and thus description thereof is omitted. The digital watermark detecting device 100 transmits the digital watermark value detected from the video image to the control unit 220.

Next, the control unit 220 receives the digital watermark value from the digital watermark detecting device 100 (step S204). Here, the control unit 220 determines whether to enable the reproduction of the video image on the basis of the information indicated by the digital watermark value (step S205). That is, when the detected digital watermark value is user identification information, the control unit 220 determines whether the detected user identification information is matched with user identification information set in advance in the video player 200.

When the user identification information is matched with each other (Yes in step S205), the control unit 220 transmits a command instructing the reproduction of the video image to the video image storing unit 230. The video image storing unit 230 having received the command instructing the reproduction of the video image transits the stored video image to the reproduction unit 240 (step S206).

The reproduction unit 240 reproduces the video image having been received from the video image storing unit 230 (step S207). On the other hand, when the user identification information is not matched with each other, the control unit 220 does not enable the reproduction of the video image in the reproduction unit 240 and ends the operation of the video player 200.

The information indicated by the digital watermark value may include information indicating the reproduction time and information indicating whether the video image is pirated, and is not particularly limited so long as it can allow the control unit 220 to determine whether to enable the reproduction of the video image.

According to the video player 200 having the above-mentioned configuration, it is possible to detect a digital watermark value embedded in various digital watermark forms with high precision and to prevent the pirated video image from being reproduced.

### Third Embodiment

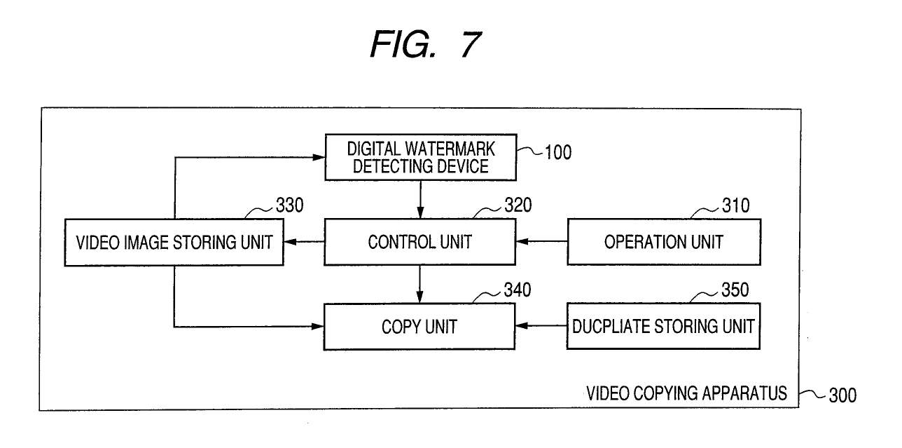

FIG. 7 is a block diagram illustrating a configuration in which the above-mentioned digital watermark detecting device 100 is mounted on a video copying apparatus 300 according to a third embodiment of the present invention. Since the configuration of the digital watermark detecting device 100 are similar to that of the first embodiment, the elements thereof are denoted by like reference numerals and description thereof is omitted.

The video copying apparatus 300 according to the third embodiment includes: an operation unit 310 to which a user performs an input operation of the video copying apparatus 300; a video image storing unit 330 that stores video image in which watermark patterns for obtaining a digital watermark value are embedded; a copy unit 340 that copies the video image from the video image storing unit 330; a copy storing unit 350 that stores the video image duplicated by the copy unit 340; a digital watermark detecting device 100 that detects the digital watermark value of the video image; and a control unit 320 that controls the copy unit 340 to enable or disable the reproduction of the video image in accordance with the digital watermark value from the digital watermark detecting device 100.

The video image storing unit 330 and the copy storing unit 350 can be embodied using a memory built in or attached to the video player 300, a hard disk, and a storage medium such as CD-R, CD-RW, DVD-RAM, and DVD-R. The copy storing unit 350 and the video image storing unit 330 may be the same storage unit.

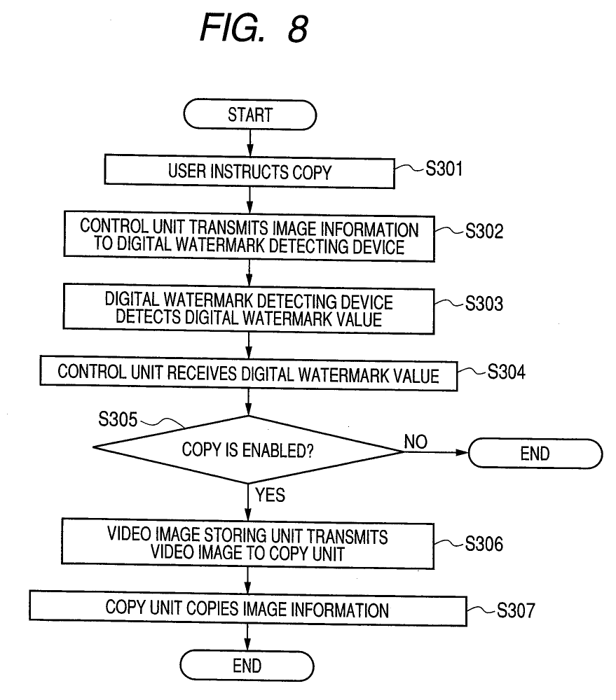

FIG. 8 shows a flowchart illustrating an operation of the video copying apparatus 300 according to the third embodiment.

First, the video copying apparatus 300 is instructed to copy the video image by means of the operation of the operation unit 310 (step s301). Here, a command instructing a copy process is transmitted to the control unit 320 from the operation unit 310 in accordance with an operation input by the user.

Then, when receiving the command instructing the copy process from the operation unit 310, the control unit 320 transmits a command for reading the stored video image and transmitting the read video image to the digital watermark detecting device 100 to the video image storing unit 330. The video image storing unit 330 having received the command reads the stored video image and transmits the read video image to the digital watermark detecting device 100 in accordance with the command (step S302).

The digital watermark detecting device 100 detects a digital watermark value from the watermark patterns embedded in the received video image (step S303). The method of allowing the digital watermark detecting device 100 to detect the digital watermark value from the video image is omitted similarly. The digital watermark detecting device 100 transmits the digital watermark value detected from the video image to the control unit 320.

Next, the control unit 320 receives the digital watermark value from the digital watermark detecting device 100 (step S304). Here, the control unit 320 determines whether to enable the copy of the video image on the basis of the information indicated by the digital watermark value (step S305). The determination method can employ the method described in the second embodiment. The information indicated by the digital watermark value is not particularly limited so long as it can allow the control unit 320 to determine whether to enable the copy of the video image.

When determined that the copy of the video image is not enabled on the basis of the information indicated by the digital watermark value (No in step S305), the control unit 320 ends the operation of the video copying apparatus 300.

On the other hand, when the control unit 320 determines that the copy of the video image is enabled on the basis of the information indicated by the digital watermark value (Yes in step S305), the control unit 320 transmits a command instructing the copy of the video image to the video image storing unit 330. The video image storing unit 330 having received the command reads the stored video image and transmits the read video image to the copy unit 340 (S306).

Then, the copy unit 340 stores (copies) the video image received from the video image storing unit 330 in the copy storing unit 350 (step S307).

According to the video player 300 having the above-mentioned configuration, it is possible to detect a digital watermark value embedded in various digital watermark forms with high precision and to prevent the pirated video image from being reproduced.

### Fourth Embodiment

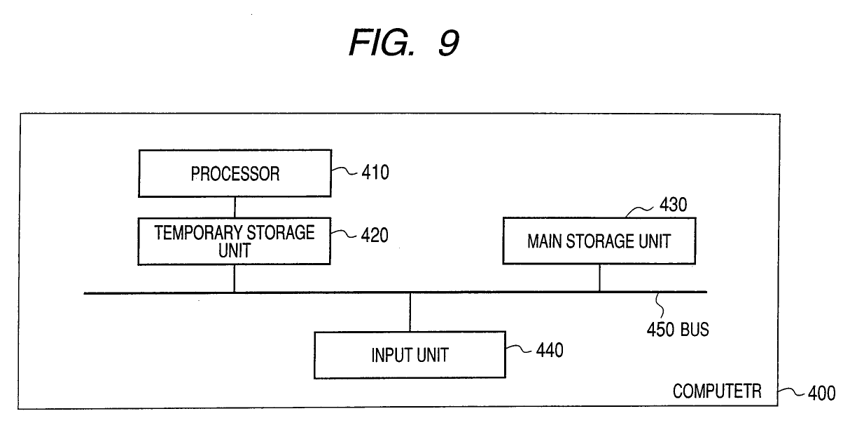

An example of a computer 400 executing a digital watermark detecting program according to a fourth embodiment of the present invention will be described with reference to FIG. 9.

The computer 400 includes, for example, a processor 410, a temporary storage unit 420, a main storage unit 430, a bus 450, and an input unit 440.

The processor 410 receives data input from the input unit 440 and data stored in the main storage unit 430 through the bus 450 and the temporary storage unit 420 and performs a calculation operation in accordance with a command included in the data.

The temporary storage unit 420 is a unit for storing temporary or transitional data. The temporary storage unit 420 is disposed between the processor 410 and the main storage unit 430. The temporary storage unit 420 may be embodied by a cache memory or a local memory. The program read from the main storage unit 430 is loaded into the temporary storage unit 420. Constants and variables used in the program are stored in the temporary storage unit 420 or a register (not shown) built in the processor 410.

The main storage unit 430 stores data such as video image processed by the processor 410. The main storage unit 430 stores, for example, OS (Operating System), application programs, data, and drivers controlling peripheral devices, which are read from the input unit 440.

The bus 450 is a transmission path used to transmit commands or data between the constituent units of the computer 400.

The input unit 440 is a unit for inputting and outputting data or software with respect to an external device of the computer 400, such as a media drive or a network interface. The video image including the watermark patterns is stored in the main storage unit 430 and the temporary storage unit 420 or the input unit 440.

The digital watermark detecting program executed by the processor 410 detects the digital watermark value embedded in the video image stored in the main storage unit 430 and the temporary storage unit 420. The digital watermark form, the pattern embedding method, the pattern extracting method, and the degrees of correlation are the same as described in the first embodiment and description thereof is omitted.

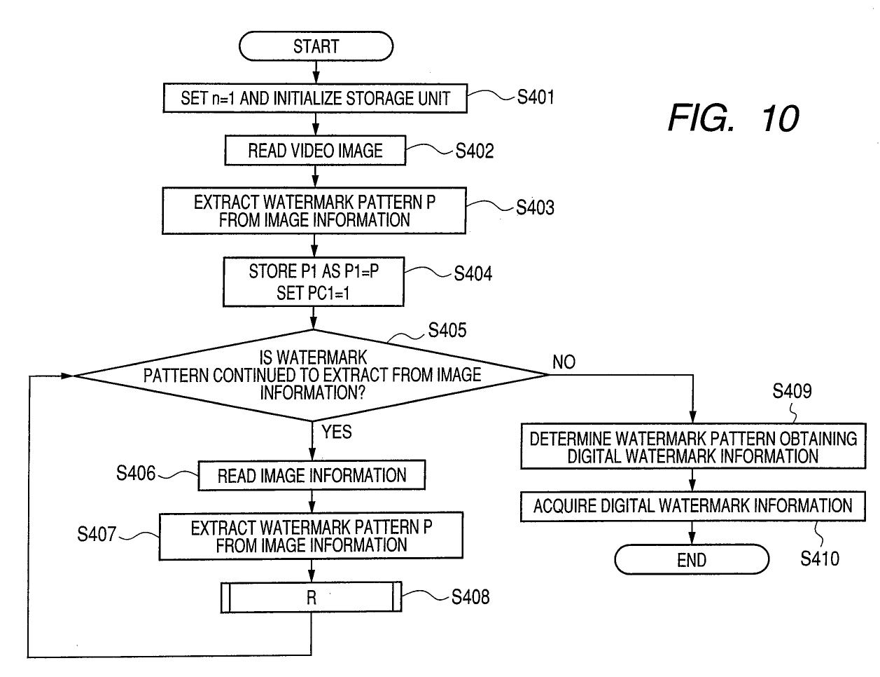

FIG. 10 is a flowchart illustrating the program executed by the computer 400 according to the fourth embodiment.

First, two variables of the accumulated information piece of the watermark patterns and the number of accumulation times are stored as a set in the temporary storage unit 420. The number of accumulation times of the watermark pattern number “n” (where n is an integer equal to or larger than zero) is written as “PCn” (where PCn is an integer equal to or larger than zero) and the accumulated information piece is written as “Pn”. The watermark pattern number “n” is a variable for identifying the type of the watermark pattern. A dummy variable “i” (where i is an integer equal to or larger than zero), a variable “CMAX” for storing the largest degree of correlation, a variable “max” (max is an integer equal to or larger than zero) for storing the pattern number of the accumulated information piece having the largest degree of correlation, and temporary variables used for calculation are stored in the temporary storage unit 420.

The processor 410 sets the watermark pattern number “n” stored in the temporary storage unit 420 to “1” and initializes the accumulated information piece “P1” and the number of accumulation times “PC1” to “0” (step S401).

Then, the processor 410 reads the video image from the main storage unit 430 (step S402). The watermark patterns obtaining the digital watermark values are embedded in the video image.

The processor 410 extracts the watermark pattern “P” from the read video image (step S403).

The processor 410 stores the extracted watermark pattern “P” as the accumulated information piece “P1” and sets the number of accumulation times “PC1” of the watermark pattern to “1” (step S404).

The processor 410 determines whether to continue to extract the watermark patterns from the video image (step S405). The method of determining whether to continue to extract the watermark patterns from the video image is the same as step S106 of FIG. 3 according to the first embodiment and thus description thereof is omitted.

Here, when the processor 410 determines that the watermark pattern is not continued to extract from the video image (No in step S405), the processor acquires a digital watermark value based on the information (the number of accumulation times “PCn” and the accumulated information piece “Pn”) stored in the temporary storage unit 420 at that time (steps S409 and S410).

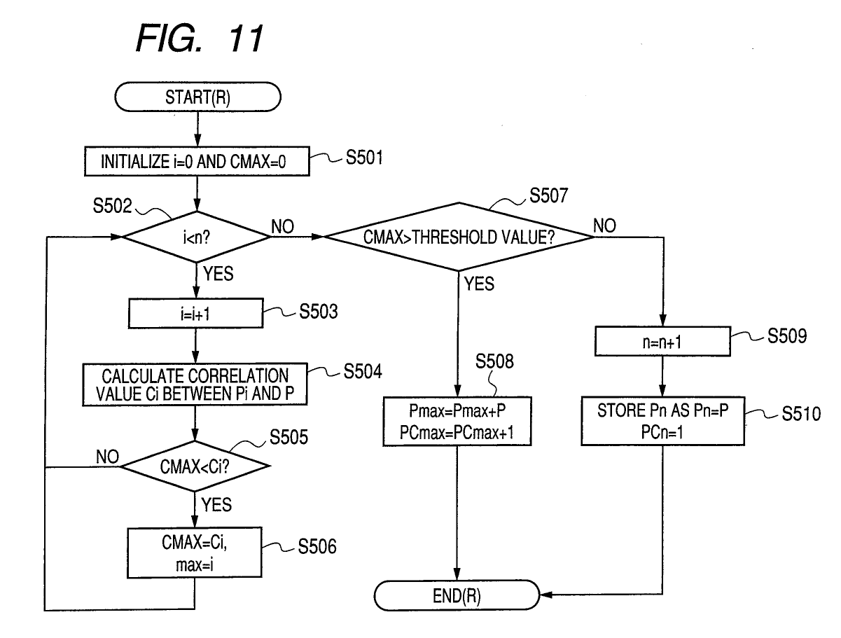

On the other hand, when the processor 410 determines that the watermark pattern is continued to extract from the video image (Yes in step S405), the processor 410 reads the video image from the main storage unit 430 (step S406). Then, similarly to step S403, the processor 410 extracts the watermark pattern “P” from the watermark patterns embedded in the video image (step S407). The processor 410 executes routine “R” shown in FIG. 11 (step S408) and then performs again the process of step S405.

A flowchart of routine “R” shown in FIG. 11 will be described.

First, the processor 410 initializes the dummy variable “i” to “0” and initializes the variable “CMAX” for storing the largest degree of correlation to “0” (step S501).

The processor 410 compares the dummy variable “i” with the pattern number “n” (step S502).

When the dummy variable “i” is less than the watermark pattern number “n”, the processor 410 increases the dummy variable “i” by 1 (i=i+1) in accordance with the digital watermark detecting program (step S503).

Next, the processor 410 calculates the degree of correlation “Ci” between the extracted watermark pattern “P” and the accumulated information piece “Pi” stored in the temporary storage unit 420 (step S504).

The processor 410 compares the degree of correlation “Ci” calculated in step S504 with the variable “CMAX” stored in the temporary storage unit 420 (step S505). When the degree of correlation “Ci” is larger than the variable “CMAX” (Yes in step S505), the processor 410 determines that the accumulated information piece “Pi” is the most similar to the watermark pattern “P” at that time.

The processor 410 substitutes the degree of correlation “Ci” for the variable “CMAX” (step S506). The processor 410 substitutes the extracted watermark pattern “P” and the watermark pattern number “i” of the accumulated information piece “Pi” for the variable “max” (step S506). Then, the processor performs the process of step S502 again.

On the other hand, when the degree of correlation “Ci” is not larger than the variable “CMAX” (Yes in step S505), the processor 410 determines that the accumulated information piece “Pmax” is more similar to the watermark pattern “P” than the accumulated information piece “Pi” and performs the process of step S502 again.

Accordingly, so long as the dummy variable “I” is less than the pattern number “n” in step S502, the processes of steps S502 to S506 are repeatedly performed. That is, the processor 410 calculates the degrees of correlation between the extracted watermark pattern “P” and all the accumulated information pieces “Pi” (where 1□i<n) stored in the temporary storage unit 420.

Accordingly, among the accumulated information pieces “Pi” (where 1≦i<n) stored in the temporary storage unit 420, the watermark pattern number of the accumulated information piece having the largest degree of correlation with the extracted watermark pattern “P” is stored in “max” and the degree of correlation is stored in “CMAX”.

When the dummy variable “i” is not less than the watermark pattern number “n” (No in step S502), the processor 410 compares the variable of the largest degree of correlation “CMAX” with the threshold value (step S507). When the largest degree of correlation “CMAX” is not larger than the threshold value (No in step S507), the processor 410 determines that the degree of correlation is small and thus the extracted watermark pattern “P” is a type different from the accumulated information piece “Pmax”. Accordingly, the processor 410 determines that the extracted watermark pattern “P” is a new type of watermark pattern different from any accumulated information piece stored in the temporary storage unit 420.

In order to identify the new type of watermark pattern, the processor 410 increases the watermark pattern number “n” by 1 (n=n+1) (step S509). The processor 410 substitutes the extracted watermark pattern “P” for the accumulated information piece “Pn” of the watermark pattern number “n” and substitutes “1” for the number of accumulation times “PCn” (step S510).

The processor 410 newly secures memory areas (memory areas for Pn and PCn) of the temporary storage unit 420 in step S510. Here, when the memory areas are not newly secured in the temporary storage unit 420, the processor 410 initializes the set of the number of accumulation times and the accumulated information piece, the number of accumulation times of which is the smallest and which is stored in the temporary storage unit 420 for the longest time, to “0” and performs the process of step S510.

On the other hand, when determined in step S507 that the largest degree of correlation “CMAX” is larger than the threshold value (Yes in step S507), the processor 410 determines that the degree of correlation is great and that the extracted watermark pattern “P” is of the same type as the accumulated information piece “Pmax”.

Then, the processor 410 accumulates the extracted watermark pattern “P” in the accumulated information piece “Pmax”. That is, the processor 410 sets a new accumulated information piece by accumulating “P” in the current value of the accumulated information piece “Pmax” and increases the number of accumulation times “PCmax” by 1 (PCmax+1) (step S508).

When one of steps S508 and S510 is ended and the routine “R” (step S408 in FIG. 10) is ended, the process of step S405 shown in FIG. 10 is performed again. Thereafter, the processes of steps S405 to S408 are repeatedly performed until the processor 410 determines in step S405 that the watermark pattern is not continued to extract from the video image.

On the other hand, when the processor 410 determines in step S405 that the watermark pattern is not continued to extract from the video image, the processor 410 determines a watermark pattern used to obtain a digital watermark value from the accumulated information pieces (step S409). That is, in the digital watermark form in which one digital watermark value is obtained by three types of watermark patterns, the processor 410 selects three accumulated information pieces in the order decreasing from the largest number of accumulation times as the watermark patterns used to acquire the digital watermark value. For example, in the digital watermark form in which one digital watermark value is obtained by one type of watermark pattern, the processor 410 can select the accumulated information piece having the largest number of accumulation times as the watermark pattern used to acquire the digital watermark value.

Next, the processor 410 acquires the digital watermark value from the selected accumulated information pieces (step S410). That is, the processor 410 acquires one digital watermark value (Dn) (where n is a positive integer) on the basis of the selected three types of accumulated information pieces (the watermark pattern of Xn, the watermark pattern of Yn, ad the watermark pattern of Zn).

Accordingly, in the digital watermark detecting program according to the fourth embodiment, it is possible to enhance the detection precision of a digital watermark value in the digital watermark form in which a digital watermark value is obtained by plural types of watermark patterns.

When the same type of watermark patterns are not embedded continuously in the frames of the video image in the digital watermark form in which a digital watermark value is obtained by one type of watermark patterns, for example, when different types of watermark patterns are alternately embedded as shown in FIG. 4 of the first embodiment, the digital watermark detecting pattern according to the fourth embodiment can be applicable.

It is to be understood that the present invention is not limited to the specific embodiment described above and that the invention can be embodied with the components modified without departing from the spirit and scope of the invention. The invention can be embodied in various forms according to appropriate combinations of the components disclosed in the embodiment described above. For example, some components may be deleted from all components shown in the embodiment. Further, the components in different embodiments may be used appropriately in combination.

What is claimed is:

1. A device for detecting digital watermark from video image in which a plurality of types of watermark patterns are embedded, the device comprising:
a reception unit that receives the video image;
an extraction unit that extracts the watermark patterns from the video image;
a storage unit that stores an accumulated information pieces and a number of accumulation times, the accumulated information pieces being obtained by accumulating the watermark patterns for each type of the watermark patterns;
a calculation unit that calculates degrees of correlation between the accumulated information pieces stored in the storage unit and the watermark patterns extracted by the extraction unit;
an accumulation unit that accumulates the watermark patterns extracted by the extraction unit in one of the accumulated information pieces having the degree of correlation that is larger than a threshold value and is the largest among the calculated degrees of correlation;
a selection unit that selects a top N-pieces of the accumulated information pieces stored in the storage unit having largest number of the accumulation times, where N is a positive integer; and
a watermark value calculation unit that obtains a digital watermark value from the accumulated information pieces selected by the selection unit.

2. The device according to claim 1, wherein the digital watermark value is obtained from N-types of the watermark patterns, where N is the positive integer.

3. The device according to claim 1, wherein the digital watermark value is obtained from one of the types of the watermark patterns, and
wherein each of the watermark patterns different in the types are alternatively embedded in the video image.

4. The device according to claim 1, wherein the watermark patterns are configured based on a phase-invariant quantity.

5. A video player comprising:
the device according to claim 1;
a video storage unit that stores the video image;
a reproduction unit that reproduces the video image stored in the video storage unit;
a control unit that controls the reproduction unit to enable or disable the reproduction of the video image based on the digital watermark value obtained by the watermark value calculation unit.

6. A video copying apparatus comprising:
the device according to claim 1;
a first video storage unit that stores the video image embedded with the watermark patterns;
a second video storage unit that stores a copy of the video image stored in the first video storage unit;
a copying unit that copies the video image stored in the first video storage unit to the second video storage unit; and
a control unit that controls the copying unit to enable or disable the copy of the video image based on the digital watermark value obtained by the watermark value calculation unit.

7. A computer-readable storage medium that contains a software program for causing a computer to perform a process for detecting digital watermark from video image in which a plurality of types of watermark patterns are embedded, the process comprising:
receiving the video image;
extracting the watermark patterns from the video image;
storing an accumulated information pieces and a number of accumulation times, the accumulated information pieces being obtained by accumulating the watermark patterns for each type of the watermark patterns;
calculating degrees of correlation between the stored accumulated information pieces and the watermark patterns;
accumulating the watermark patterns in one of the accumulated information pieces having the degree of correlation that is larger than a threshold value and is the largest among the calculated degrees of correlation;
selecting a top N-pieces of the stored accumulated information pieces having largest number of the accumulation times, where N is a positive integer; and
obtaining a digital watermark value from the selected accumulated information pieces.
